(19) United States
(12) Patent Application Publication
(10) Pub. No.: US 2012/0313693 A1
(43) Pub. Date: Dec. 13, 2012

(54) SEMICONDUCTOR DEVICE, METHOD AND SYSTEM WITH LOGIC GATE REGION RECEIVING CLOCK SIGNAL AND BODY BIAS VOLTAGE BY ENABLE SIGNAL

(75) Inventors: Kyung Tae Do, Changwon-si (KR); Hyung Ock Kim, Seoul (KR); Hyo Sig Won, Suwon-si (KR); Jung Yun Choi, Hwaseong-si (KR)

(73) Assignee: SAMSUNG ELECTRONICS CO., LTD., Suwon-si (KR)

(21) Appl. No.: 13/491,110

(22) Filed: Jun. 7, 2012

(30) Foreign Application Priority Data
Jun. 9, 2011 (KR) 10-2011-0055650

(51) Int. Cl. G05F 3/02

(52) U.S. Cl. 327/535

(57) ABSTRACT

A method of controlling the provision of a body bias voltage to a logic gate region of a semiconductor device includes; gating application of a clock signal applied to a synchronization element in the logic gate region in accordance with an enable signal, and providing the body bias voltage to each body terminal of a plurality of logic gates arranged in the logic gate region in accordance with the enable signal.

### CROSS-REFERENCE TO RELATED APPLICATION

This application claims priority under 35 U.S.C. §119 from Korean Patent Application No. 10-2011-0055650 filed on Jun. 9, 2011, the subject matter of which is hereby incorporated by reference.

### BACKGROUND OF THE INVENTION

Embodiments of the present inventive concept relate to semiconductor devices, and more particularly, to methods of operating semiconductor device that use an enable signal to gate application of a clock signal to a synchronization element within a logic gate region.

Leakage of circuit in an electronic circuits includes both standby leakage and active leakage. Standby leakage is leakage occurring when the electronic circuit is in a standby mode of operation. Active leakage is leakage occurring during an active (or operating) mode of operation, albeit under conditions wherein no change in a particular voltage or current signal is intended. Leakage has become an increasingly significant issue in the overall power performance of contemporary electronics, and particularly mobile electronic devices. In this regard, standby leakage may be effectively reduced using certain power gating technologies. However, the effective control of active leakage remains a significant concern.

### SUMMARY OF THE INVENTION

Certain embodiments of the inventive concept are directed to a method of controlling the provision of a body bias voltage to a logic gate region of a semiconductor device, the method comprising; gating application of a clock signal applied to a synchronization element in the logic gate region in accordance with an enable signal, and providing the body bias voltage to each body terminal of a plurality of logic gates arranged in the logic gate region in accordance with the enable signal.

Certain embodiments of the inventive concept are directed to a semiconductor device comprising; a logic gate region including a synchronization element responsive to a clock signal and a plurality of logic gates each respectively including a body terminal, wherein each body terminal receives a body bias voltage in response to an enable signal, and a gating circuit that receives the clock signal and provides the clock signal to the synchronization element in accordance with the enable signal.

Certain embodiments of the inventive concept are directed to a semiconductor system comprising; a semiconductor device, and a controller that controls operation of the semiconductor device, wherein the semiconductor device comprises; a logic gate region including a synchronization element responsive to a clock signal and a plurality of logic gates each respectively including a body terminal, wherein each body terminal receives a body bias voltage in response to an enable signal, and gating circuit that receives and provides the clock signal to the synchronization element in accordance with the enable signal.

### BRIEF DESCRIPTION OF THE DRAWINGS

These and/or other aspects and advantages of the inventive concept will become apparent and more readily appreciated from the following description of the embodiments, taken in conjunction with the accompanying drawings of which:

FIG. 1 is a partial schematic circuit diagram of a semiconductor device according to an embodiment of the inventive concept;

FIG. 2 is a circuit diagram further illustrating the body bias voltage control circuit of FIG. 1;

FIG. 3 is a cross-sectional diagram and a plane diagram of the semiconductor device of FIG. 1;

FIG. 4 is a partial schematic circuit diagram of the semiconductor device according to another embodiment of the inventive concept;

FIG. 5 is a circuit diagram further illustrating the body terminal cell of FIG. 4;

FIG. 6 is a block diagram of a body bias voltage generator capable of generating body bias voltages such as those described in relation to FIGS. 1, 3 and 4;

FIG. 7 is a partial schematic circuit diagram of the semiconductor device according to still another embodiment of the inventive concept;

FIG. 8 is a partial schematic circuit diagram of the semiconductor device according to still another embodiment of the inventive concept;

FIG. 9 is a waveform diagram for input/output signals for the phase control circuit illustrated in FIGS. 7 and 8;

FIG. 10 is a circuit diagram further illustrating the phase control circuit illustrated in

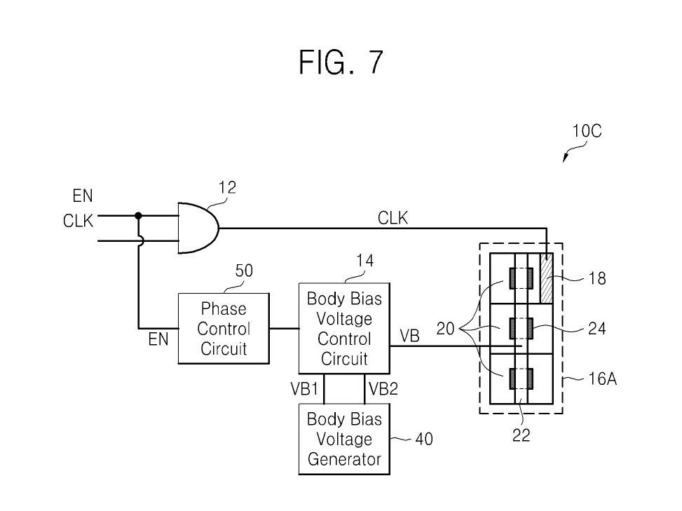

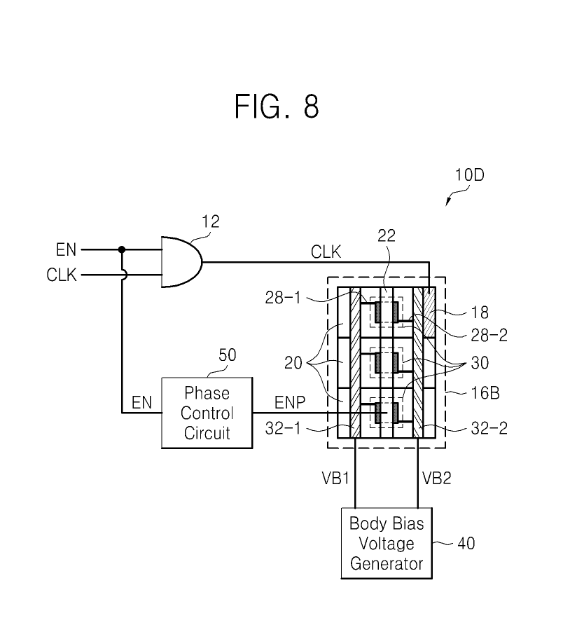

FIGS. 7 and 8;

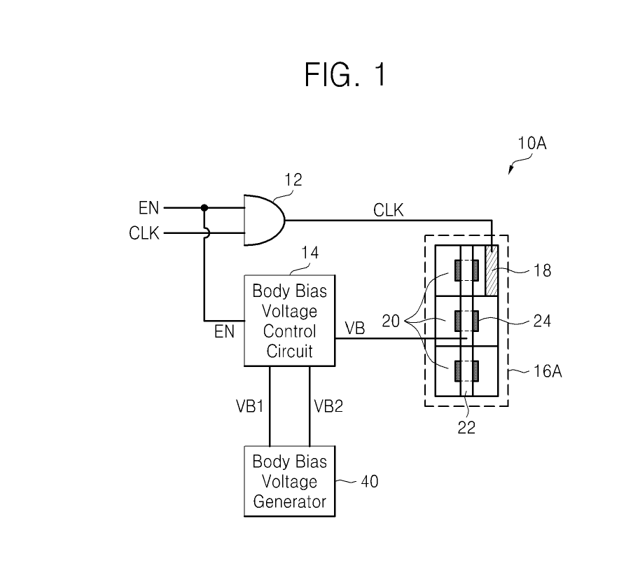

FIG. 11 is a layout diagram for the logic gate region of FIGS. 1, 4, 7 and 8;

FIG. 12 is a cross-sectional diagram of the logic gate region illustrated in FIG. 11;

FIG. 13 is a flowchart summarizing a body bias voltage control method for a semiconductor device according to an embodiment of the inventive concept;

FIG. 14 is a flowchart summarizing a body bias voltage control method for a semiconductor device according to another embodiment of the inventive concept;

FIG. 15 is a flowchart summarizing a body bias voltage control method for a semiconductor device according to still another embodiment of the inventive concept;

FIG. 16 is a flowchart summarizing a body bias voltage control method for a semiconductor device according to still another embodiment of the inventive concept;

FIG. 17 is a block diagram of a semiconductor system including a semiconductor device according to an embodiment of the inventive concept;

FIG. 18 is a block diagram of another semiconductor system including a semiconductor device according to an embodiment of the inventive concept;

FIG. 19 is a block diagram of another semiconductor system including a semiconductor device according to an embodiment of the inventive concept;

FIG. 20 is a block diagram of another semiconductor system including a semiconductor device according to an embodiment of the inventive concept;

FIG. 21 is a block diagram of still another semiconductor system including a semiconductor device according to an embodiment of the inventive concept; and

FIG. 22 is a block diagram of still another semiconductor system including a semiconductor device according to an embodiment of the inventive concept;

### DETAILED DESCRIPTION

Reference will now be made in some additional detail to certain embodiments of the inventive concept, as illustrated in the accompanying drawings. Throughout the drawings and written description, like reference numbers and labels will be used to denote like or similar elements and signals. The illustrated embodiments are presented to teach the making and use of the inventive concept but should not be considered dispositive to the scope of the inventive concept.

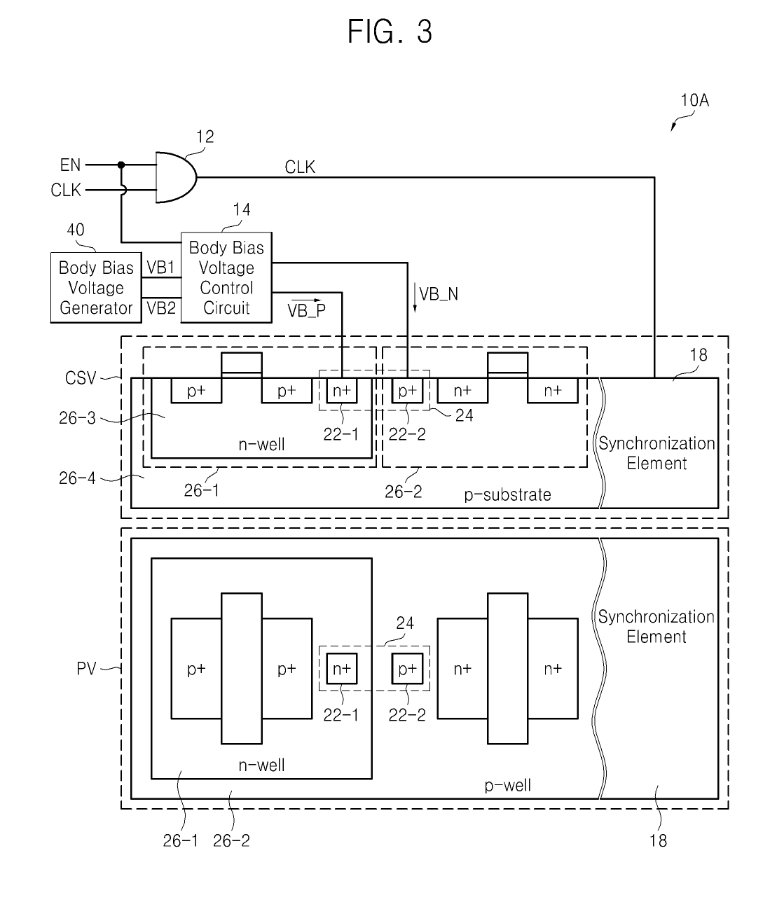

FIG. 1 is a partial schematic block diagram of a semiconductor device according to an embodiment of the inventive concept. FIG. 3 is a cross-sectional diagram and a plane diagram of the semiconductor device illustrated in FIG. 1 and serves to expand upon the description of FIG. 1. Referring to FIGS. 1 and 3, a semiconductor system 10A generally comprises a gating circuit 12, a body bias voltage control circuit 14, a logic gate region 16A and a body bias voltage generator 40.

The semiconductor device 10A may be embodied in a memory device or a non-memory device.

Memory devices susceptible to the incorporation of an embodiment of the inventive concept include both volatile and non-volatile memory devices. Such volatile memory devices include dynamic random access memory (DRAM), static random access memory (SRAM), thyristor RAM (T-RAM), zero capacitor RAM (Z-RAM), and/or Twin Transistor RAM (TTRAM). Such non-volatile memory devices include electrically erasable programmable read-only memory (EEPROM), flash memory, magnetic RAM (MRAM), conductive bridging RAM (CBRAM), Ferroelectric RAM (FeRAM), Phase change RAM (PRAM) and/or a Resistive RAM (RRAM or ReRAM).

Non-memory devices susceptible to the incorporation of an embodiment of the inventive concept include central processing units (CPU), micro-components, logic circuits, application specific integrated circuits (ASIC), analog integrated circuits (IC), Systems on Chip (SoC), and/or Network on Chip (NoC). Micro-component may include micro-processors, micro-controllers, micro-peripheral circuits, and/or digital signal processors. Logic circuits may include standard logic, full-custom IC and other type of logic circuits. ASICs may include cell-based ICs, programmable logic devices (PLD) and gate arrays.

However, the foregoing enumerated circuits types, both memory and non-memory, are merely exemplary. Those skilled in the art will understand that various embodiments of the inventive concept may be applied to semiconductor circuits using clock gating.

Returning to FIGS. 1 and 3, the gating circuit 12 may be used to apply a clock signal CLK as a function of (or in accordance with) an enable signal EN. In certain contexts, the gating circuit 12 may be thought of as a mask circuit. In the illustrated example, the gating circuit 12 is embodied by a simple AND gate and it is assumed that a logically “high” enable signal EN passes the clock signal CLK to the clock terminal of a synchronization element 18 (e.g., a flip-flop) of the logic gate region 16A.

The body bias voltage control circuit 14 selectively provides one of a plurality of body bias voltages (e.g.) VB1 and VB2 generated to the body bias voltage generator 40 as a function of the enable signal EN.

The logic gate region 16A also includes in addition to the synchronization element 18, a plurality of logic gates 20 including a body terminal network 22 and a plurality of body terminal cells 24. The synchronization element 18 may be embodied using any element (one of many different flip flop circuits, for example) capable of operating in synchronization with the applied clock signal CLK provided by the gating circuit 12.

The plurality of logic gates 20 may include various types of Boolean logic gates (e.g., AND gates, OR gates, NOR gates, exclusive OR (XOR) gates, and/or exclusive NOR (XNOR) gates).

The body terminal network 22 is connected to each one of the plurality of body terminal cells 24 within the plurality of logic gates 20. Accordingly, a selected body bias voltage VB provided by the body bias voltage control circuit 14 may be applied to the body terminal (e.g.) 22-1 or 22-2 included in each of the body terminal cells 24 through the body terminal network 22.

The logic gate region 16A where a body bias voltage VB is applied may include a fan-in logic cone and/or a fan-out logic cone disposed before and/or after the synchronization element 18. The fan-in logic cone may include logic gates only affecting an input of the synchronization element 18, and the fan-out logic cone may include logic gates affected only by an output of the synchronization element 18.

To connect the body terminals 22-1 and 22-2, each body terminal cell 24 may be disposed around the respective body terminals 22-1 and 22-2.

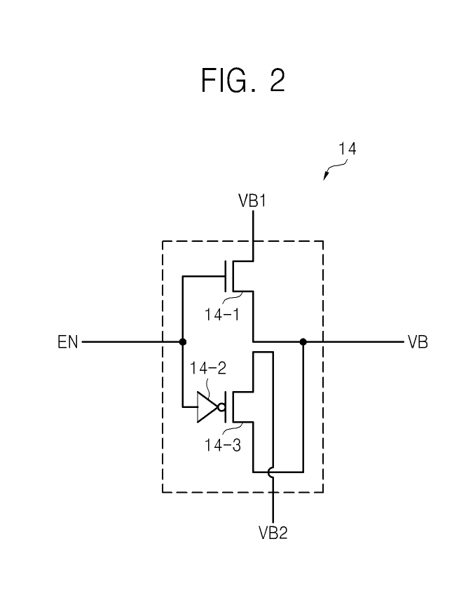

FIG. 2 is a circuit diagram further illustrating in on embodiment the body bias voltage control circuit 14 of FIG. 1. Referring of FIG. 2, the body bias voltage control circuit 14 comprises a first switch 14-1, an inverter 14-2 and a second switch 14-3. The first switch 14-1 provides a first body bias voltage VB1 as a body bias voltage VB in response to the enable signal EN, and may be embodied as a MOS transistor. The inverter 14-2 inverts the enable signal EN.

The second switch 14-3 provides a second body bias voltage VB2 as a body bias voltage VB in response to an output signal of the inverter 14-2, and may also may be embodied as a MOS transistor. With this configuration, the body bias voltage control circuit 14 may provide the first body bias voltage VB1 as a body bias voltage VB when the enable signal EN is high, or provide the second body bias voltage VB2 as a body bias voltage VB when the enable signal EN is low.

Referring now to FIGS. 1, 2 and 3, a cross-sectional view (CSV) and a related plane view (PV) of the semiconductor device 10A will now be considered in some additional detail.

The body bias voltage control circuit 14 is assumed to provide a positive (+) body bias voltage VB_P to a first body terminal 22-1 of a PMOS transistor, and a negative (−) body bias voltage VB_N to a second body terminal 22-2 of a NMOS transistor. In certain embodiments, at least one of VB_P and VB_N is equal to the body bias voltage VB provided by the circuit of FIG. 2.

As suggested by FIG. 3, when a plurality of PMOS transistors and a plurality of NMOS transistors are arranged on a constituent P-type substrate 26-4, each body of the plurality of NMOS transistors may be directly disposed within the P-type substrate 26-4 such that the plurality of NMOS transistors essentially “share” a body formed by the P-type substrate 26-4.

However, when each body of the plurality of NMOS transistors—as provided in a logic gate region 16A receiving a basic body bias voltage—are disposed in a common substrate portion, albeit being operationally separated from one another, it is often desirable to further provide a body bias voltage (e.g., VB_N in the illustrated example) to each respective body terminal (e.g., 22-2) of each respective one of the plurality of NMOS transistors in the logic gate region 16A.

For example, the basic body bias voltage may be a body bias voltage applied to a NMOS transistor and/or a PMOS transistor when a forward or a reverse body bias voltage is not applied. As a result in certain embodiments, one of the first body bias voltage VB1 and the second body bias voltage VB2 may be a basic body bias voltage. Thus, it is possible in certain embodiments for a source voltage (e.g., a negative, ground or VSS voltage) in case of a NMOS transistor or a drain voltage (e.g., a positive or VDD voltage) in case of a PMOS transistor to be applied as a basic body bias voltage.

In certain embodiments, although each body of the plurality of NMOS transistors in the logic gate region where a basic body bias voltage is applied, and each body of the NMOS transistors of the logic gate region 16A where a reverse or a forward body bias voltage is applied may be the same substrate, in order to electrically separate these different transistor configurations, a P-well may be incorporated within the P-type substrate.

For convenience of explanation, FIG. 3 illustrates a case wherein the P-type substrate 26-4 is used. However, those skilled in the art will recognize that a N-type substrate might be used in other embodiments of the inventive concept. In cases where an N-type substrate is used, each body of a plurality of PMOS transistors, embodied in a logic gate region where a basic body bias voltage is applied, and each body of the PMOS transistors, embodied in the logic gate region 16A where a reverse or a forward body bias voltage is applied, may be the same substrate but may also be electrically separated, a body bias voltage VB_P might be further applied to each body terminal of the plurality of PMOS transistors embodied in the logic gate region 16A.

Consistent with the foregoing description, an N-well might be effectively used within the N-Otype substrate for this purpose.

One approach to the provision of a “separating well region”, that is, a well region that electrically separates the body of one arrangement of transistors form another arrangement of potentially differently biased transistors will now be described.

Thus, as suggested by the illustrated example of FIG. 3, a separating well region 26-3 of a first logic gate 26-1, as compared with a substrate region (or constituent well region) of a second logic gate 26-2 may be P-type or N-type, a corresponding material type may be used to form each body terminal 22-1 and 22-2 to which a body bias voltage (e.g., VB_P or VB_N) is applied.

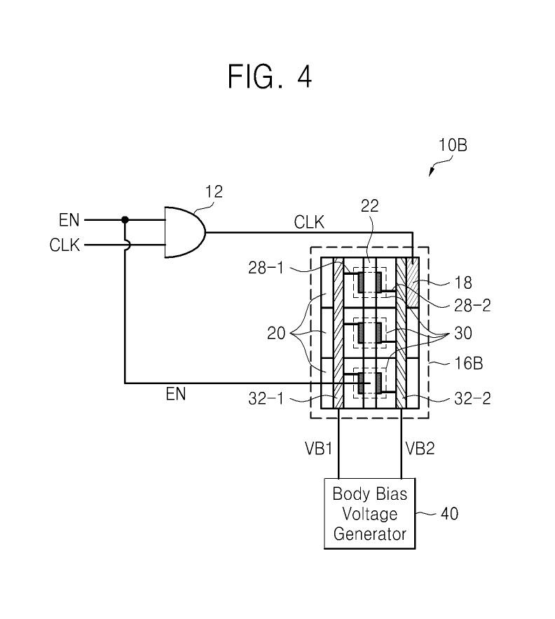

FIG. 4 is a partial schematic circuit diagram of a semiconductor device according to another embodiment of the inventive concept. Comparing the example of FIGS. 1 and 4, the body bias voltage control circuit 14 may be omitted at the expense of altering the configuration of an analogous logic gate region 16B.

The logic gate region 16B of FIG. 4 similarly comprises the synchronization element 18, the plurality of logic gates 20, the body terminal network 22, as well as a plurality of connection lines 28-1 and 28-2, a plurality of voltage supply lines 32-1 and 32-2, and a plurality of body terminal cells 30.

Each voltage supply line 32-1 or 32-2 supplies a corresponding bias voltage VB1 or VB2 to each body terminal cell 30, and may be disposed on opposite sides of the plurality of body terminal cell 30.

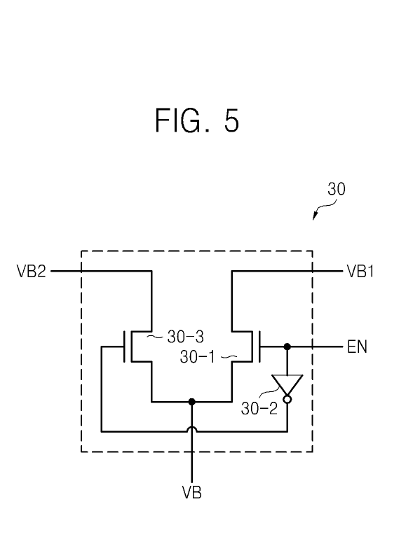

Each connection line 28-1 or 28-2 connects each voltage supply line 32-1 or 32-2 with the body terminal cell 30. Each body terminal cell 30 may supply one of a first body bias voltage VB1 and a second body bias voltage VB2 to each body terminal of each logic gate 20 according to a state of the enable signal EN as a body bias voltage (VB of FIG. 5).

FIG. 5 is a circuit diagram further illustrating in one embodiment the body terminal cell 30 of FIG. 4. Referring to FIG. 5, each body terminal cell 30 comprises a first switch 30-1, an inverter 30-2 and a second switch 30-3.

The first switch 30-1 provides a first body bias voltage VB1 as a body bias voltage VB in response to an enable signal EN. For example, the first switch 30-1 may be embodied in a MOS transistor. The inverter 30-2 inverts an enable signal EN. The second switch 30-3 provides a second body bias voltage VB2 as a body bias voltage VB in response to an output signal of the inverter 30-2. For example, the second switch 30-3 may be embodied in a MOS transistor.

For example, each body terminal cell 30 may provide a first body bias voltage VB1 as a body bias voltage VB when the enable signal EN is high, or a second body bias voltage VB2 as a body bias voltage VB when the enable signal EN is low.

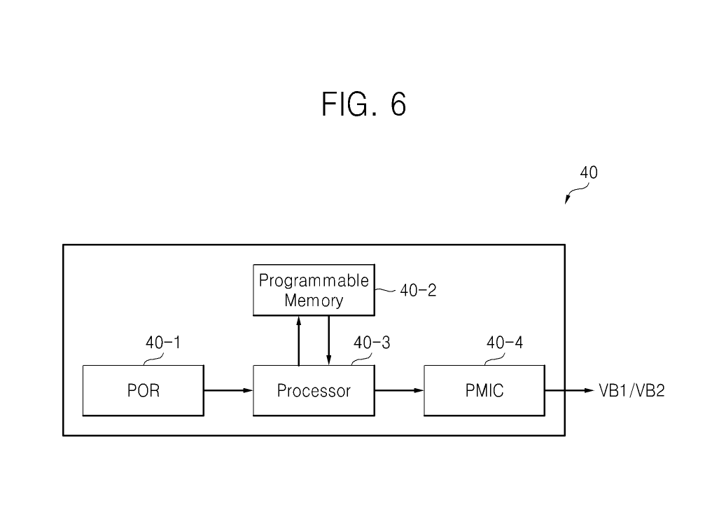

FIG. 6 is a block diagram of a body bias voltage generator capable of generating the body bias voltages described in the context of the embodiments of the inventive concept illustrated in FIGS. 1, 3 and 4. Referring to FIG. 6, the body bias voltage generator 40 comprises a power on reset (POR) circuit 40-1, a programmable memory 40-2, a processor 40-3 and a power management IC (PMIC) 40-4.

The POR 40-1 performs a reset internally in the body bias voltage generator 40. The POR 40-1 may be included in the body bias voltage generator 40 to block an error, which occurs when a power is not supplied during a short period of time or when a power gradually increases and a reset circuit embodied outside of the body bias voltage generator 40 does not operate.

The programmable memory 40-2 stores information necessary for voltage control of the processor 40-3. According to an embodiment, the information may be about a state of silicon or an operation speed required in a semiconductor device. The processor 40-3 may control a PMIC 40-4 to control a voltage according to information stored in the programmable memory 40-2.

The PMIC 40-4 may control each bias voltage VB1 or VB2 according to a command of the processor 40-3 and supply the each controlled bias voltage VB1 or VB2 to the body bias voltage control circuit 14 of FIG. 1 or each of a plurality of voltage supply lines 32-1 and 32-2 of FIG. 4.

The body bias voltage generator 40 using the PMIC 40-4 illustrated in FIG. 6 is usually embodied outside a semiconductor chip to which the inventive concept is applied. The body bias voltage generator 40 illustrated in FIG. 6 is just one example of many similar voltage generation circuits susceptible to the incorporation of an embodiment of the inventive concept.

According to certain embodiments, for example, the body bias voltage generator 40 may be embodied within a semiconductor device as a Low-Drop-Out (LDO) regulator or a switch capacitance regulator. The LDO regulator or the switch capacitance regulator may be supplied with a predetermined externally provided voltage and used to provide one or more control voltage(s) to the body bias voltage control circuit 14 of FIG. 1, or to each voltage supply line 32-1 or 32-2 of FIG. 4.

FIG. 7 is a partial schematic circuit diagram of the semiconductor device according to still another embodiment of the inventive concept. Referring to FIG. 7, a semiconductor device 10C comprises the gating circuit 12, the body bias voltage control circuit 14, the logic gate region 16A, the body bias voltage generator 40, as well as a phase control circuit 50. Referring to FIGS. 1 and 7, except for the phase control circuit 50, a configuration of the semiconductor device 10A of FIG. 1 and a configuration of the semiconductor device 10C of FIG. 7 are the same, so that explanation thereof is omitted.

The phase control circuit 50 more exactly controls the phase of the enable signal EN as provided to the body bias voltage control circuit 14. According to certain embodiments, the phase control circuit 50 may control the phase of the enable signal EN provided to the body bias voltage control circuit 14 according to a delay value, which is set considering a delay occurred when the gating circuit 12 gates an enable signal EN or when the body bias voltage VB is supplied through the body terminal network 22.

According to illustrated embodiment of FIG. 7, the phase control circuit 50 may be laid out in an output terminal of the gating circuit or an output terminal of the body bias voltage control circuit 14. However, relevant embodiments of the inventive concept are not restricted to this type of layout. For example, if the phase control circuit 50 is laid out in an output terminal of the gating circuit 12, the phase control circuit 50 may be used to control the phase of the clock signal CLK applied to the synchronization element 18.

FIG. 8 is a partial schematic circuit diagram of the semiconductor device according to still another embodiment of the inventive concept. Referring to FIG. 8, a semiconductor device 10D again includes the gating circuit 12, a logic gate region 16B, the body bias voltage generator 40 and the phase control circuit 50. Referring to FIGS. 4 and 8, except for the phase control circuit 50, a configuration of the semiconductor device 10B of FIG. 4 and a configuration of the semiconductor device 10D of FIG. 8 are the same, so that explanation thereof is omitted.

As above, the phase control circuit 50 may be used to control the phase of the enable signal EN and supply the phase-controlled enable signal ENP to the body terminal network 22. The phase control circuit 50 of FIG. 8 may be laid out in an output terminal of the gating circuit 12, but other embodiment are not restricted to this layout design. That is, as above, the phase control circuit 50 may be laid out in an output terminal of the gating circuit 12, and the phase control circuit 50 may be used to control the phase of the clock signal CLK provided to the synchronization element 18.

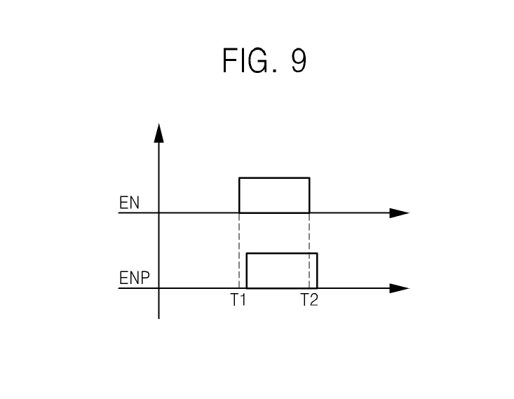

FIG. 9 is a waveform diagram describing input/output signals for the phase control circuit 50 of FIGS. 7 and 8. Referring to FIG. 9, the phase of the enable signal EN applied to the phase control circuit 50 of FIG. 7 or FIG. 8 may lead the phase of a phase-controlled enable signal ENP.

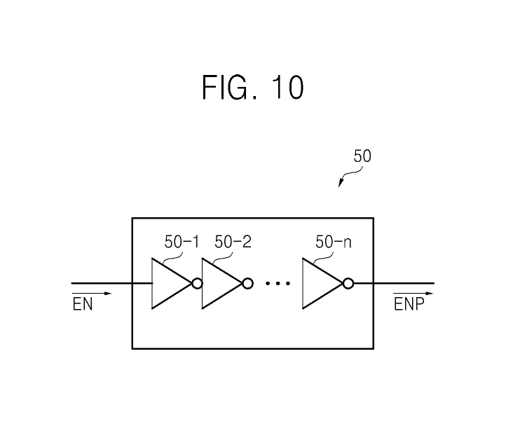

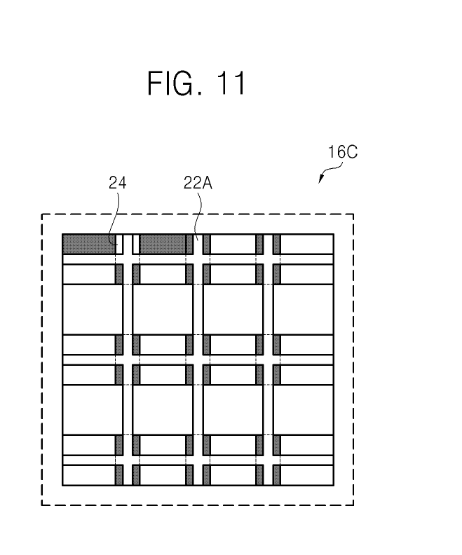

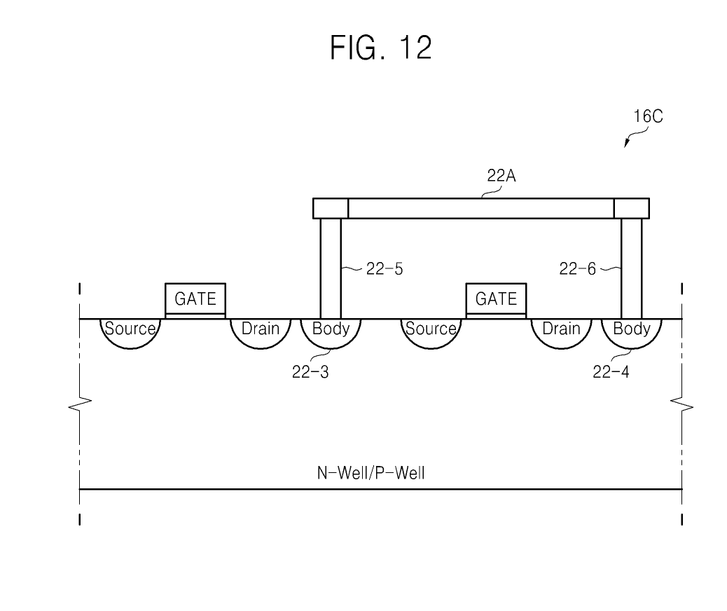

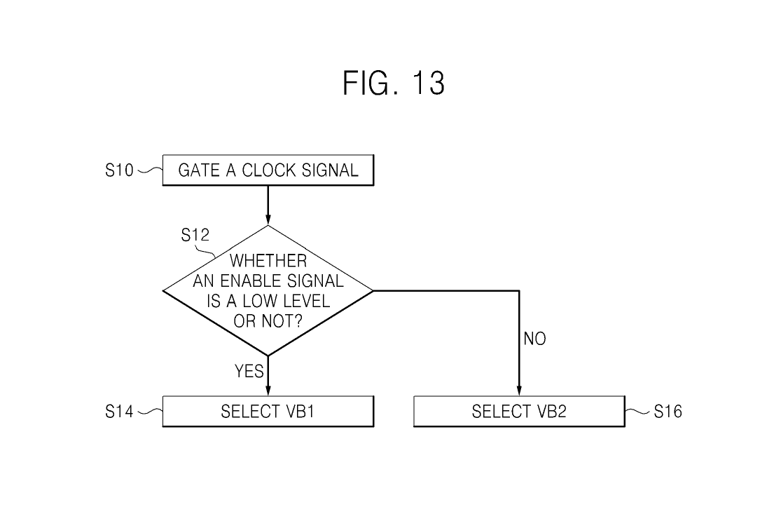

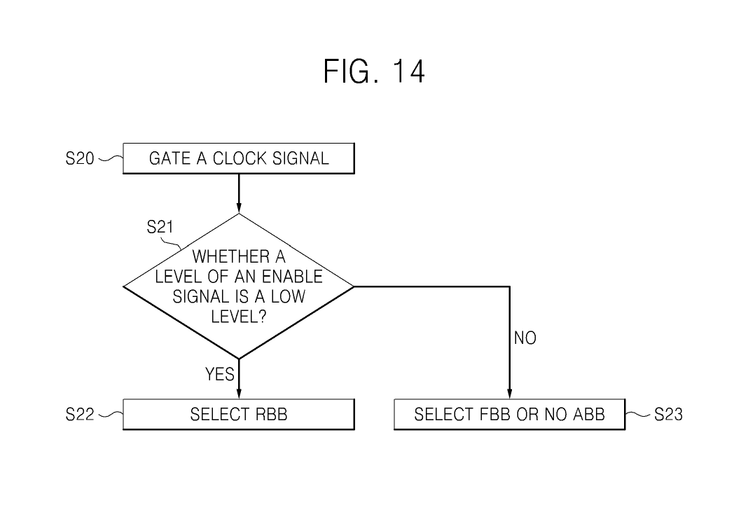

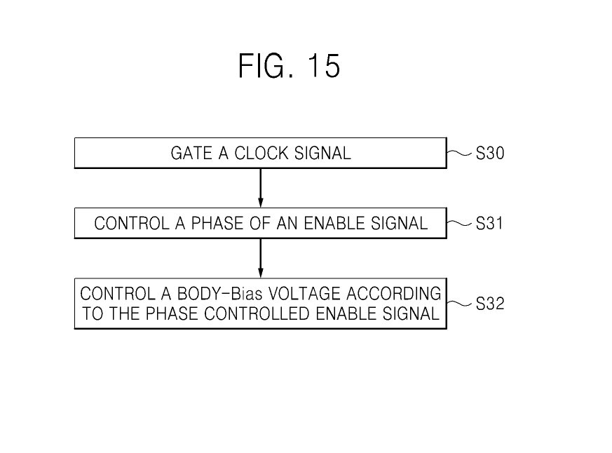

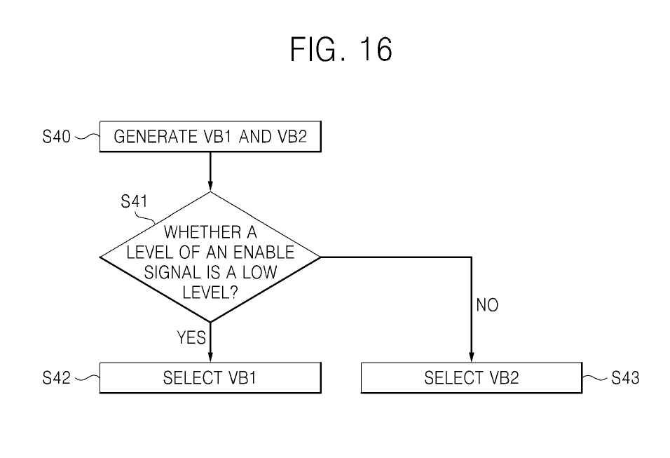

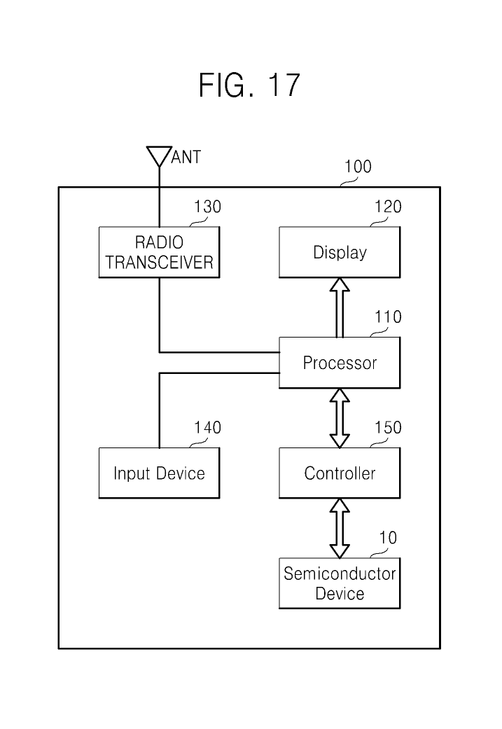

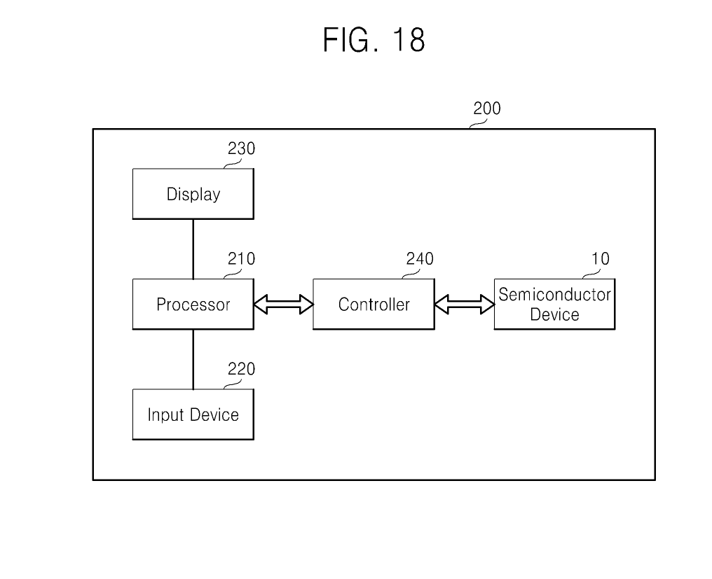

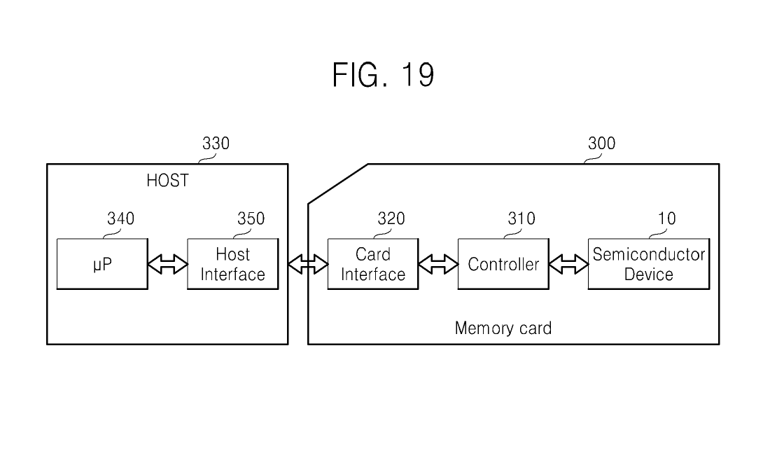

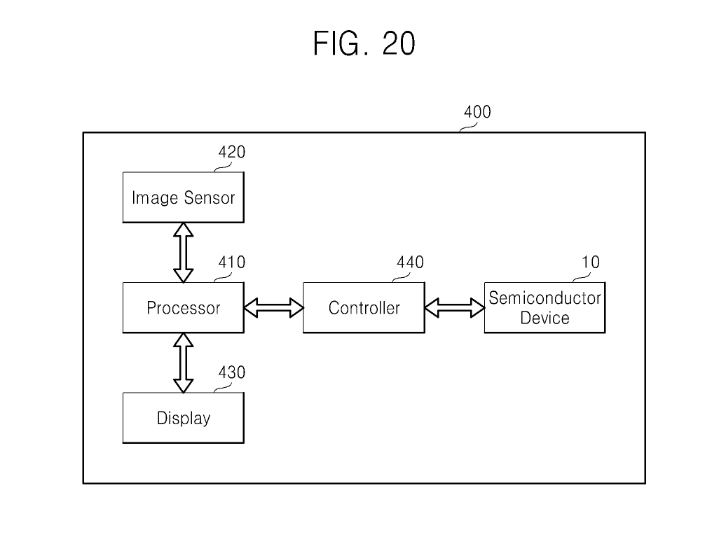

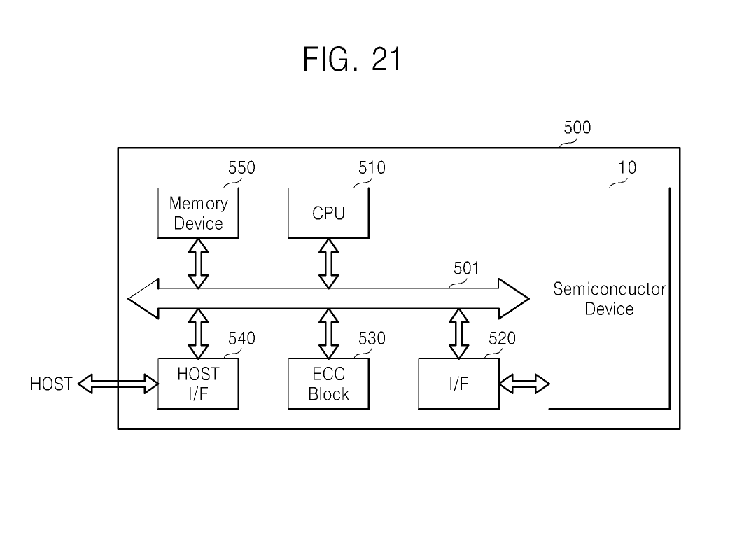

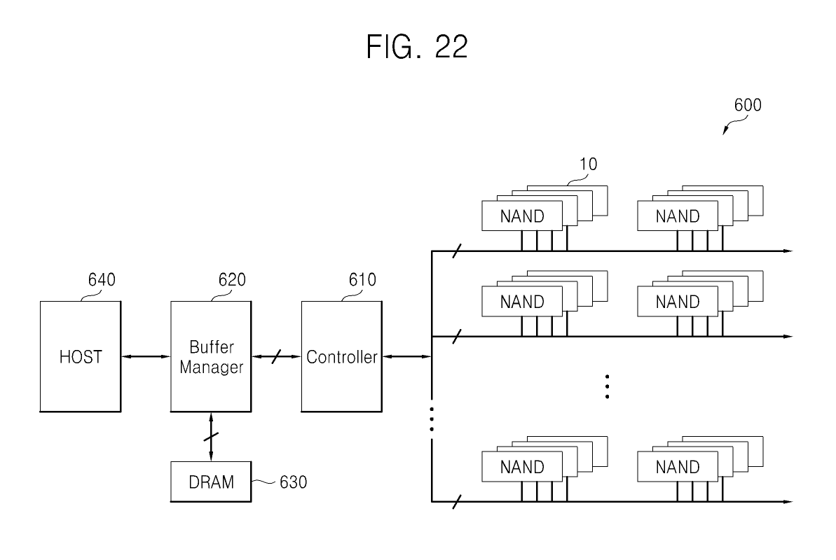

FIG. 10 further illustrates in one embodiment the phase control circuit 50 of FIGS. 7 and 8. Referring to FIGS. 9 and 10, the phase control circuit 50 comprises a first inverter 50-1, a second inverter 50-2 through an n^{th} inverter 50-n. The first inverter 50-1, the second inverter 50-2 to the n^{th} inverter 50-n delay the phase of the received enable signal EN and combine to output a phase-controlled (or phase-delayed) enable signal ENP. The number of inverters may change according to an embodiment.

The specific phase control circuit 50 suggested by FIGS. 9 and 10 is merely one ready example of a many possible embodiments that may be used and will be apparent to those skilled in the art.

FIG. 11 is a layout diagram further illustrating the disposition of various logic gate regions previously described in FIG. 1, 4, 7 or 8. Referring to FIGS. 1 and 11, a logic gate region 16C includes a plurality of body terminal cells 24 and a body terminal network 22A. The body terminal network 22A connects the plurality of body terminal cells 24 in a form of mesh. The form of mesh is not more than an embodiment and the body terminal network 22A may be embodied in a form of strap or ring.

FIG. 12 is a cross-sectional diagram further illustrating the logic gate region of FIG. 11. Referring to FIG. 12, the logic gate region 16C comprises a first body terminal 22-3, a second body terminal 22-4, a first contact 22-5, a second contact 22-6 and the body terminal network 22A.

Referring to FIGS. 11 and 12, the body terminal network 22A of FIG. 11 is the same as the body terminal network 22A of FIG. 12, so that explanation for an identical part will be omitted.

A first body terminal 22-3 is supplied with a body bias voltage through a first contact 22-5 from the body terminal network 22A. A second body terminal 22-4 is supplied with a body bias voltage through a second contact 22-6 from the body terminal network 22A.

The first contact 22-5 connects the body terminal network 22A with the first body terminal 22-3. The second contact 22-6 connects the body terminal network 22A with the second body terminal 22-4. Here, each contact 22-5 or 22-6 is explained as an example of an electrical connection means.

FIG. 13 is a flowchart summarizing a body bias voltage control method for a semiconductor device according to an embodiment of the inventive concept. Referring to FIGS. 1, 4 and 13, the gating circuit 12 receives a clock signal CLK (S10) and gates the provision of the clock signal in accordance with the state of a received enable signal EN (S12). That is, consistent with the foregoing embodiments, the body bias voltage control circuit 14 or each body terminal cell 30 may be used to determine whether the state of the enable signal is high or low.

The body bias voltage control circuit 14 or each body terminal cell 30 may supply a first body bias voltage VB1 to each body terminal of a plurality of logic gates 20 of a logic gate region 16 or 16A as a body bias voltage VB when a level of an enable signal EN is low level (S14). The body bias voltage control circuit 14 or each body terminal cell 30 may supply a second body bias voltage VB2 to each body terminal of the plurality of logic gates 20 of the logic gate region 16 or 16A when a level of an enable signal EN is high level (S16).

As another embodiment, the body bias voltage control circuit 14 or each body terminal cell 30 selects a first body bias voltage VB1 when a level of an enable signal EN is high level, and selects a second body bias voltage VB2 when a level of an enable signal EN is low level.

FIG. 14 is a flowchart summarizing a body bias voltage control method for a semiconductor device according to another embodiment of the inventive concept. Referring to FIGS. 1, 4 and 14, the gating circuit 12 receives and gates the provision of the clock signal CLK in accordance with the state of the enable signal EN (S20 and S21).

The body bias voltage control circuit 14 or each body terminal cell 30 may supply a reverse body bias RBB voltage to each body terminal of the plurality of logic gates 20 of the logic gate region 16 or 16A as a body bias voltage VB when a level of an enable signal EN is low level (S22).

The body bias voltage control circuit 14 or each body terminal cell 30 may supply a forward body bias (FBB) voltage or a basic body bias voltage to each body terminal of the plurality of logic gates 20 of the logic gate region 16 or 16A as a body bias voltage VB when a level of an enable signal EN is high level (S23).

FIG. 15 is a flowchart summarizing a body bias voltage control method for a semiconductor device according to still another embodiment of the inventive concept. Referring to FIGS. 7, 8, 9 and 15, the gating circuit 12 gates a clock signal CLK according to an enable signal EN (S30). The phase control circuit 50 controls the phase by delaying a phase of the enable signal EN (S31). According to certain embodiments, the body bias voltage control circuit 14 or each body terminal cell 30 may control a body bias voltage according to a phase-controlled enable signal ENP (S32).

FIG. 16 is a flowchart summarizing a body bias voltage control method for a semiconductor device according to still another embodiment of the inventive concept. Referring to FIGS. 1, 4, 6 and 16, the body bias voltage generator 40 generates a first body bias voltage VB1 and a second body bias voltage VB2 (S40). Then, the body bias voltage control circuit 14 or each body terminal cell 30 determines the state of the enable signal EN (S41).

The body bias voltage control circuit 14 or each body terminal cell 30 may supply a first body bias voltage VB1 to each body terminal of the plurality of logic gates 20 of the logic gate region 16 or 16A as a body bias voltage VB when a level of an enable signal EN is low level (S42). The body bias voltage control circuit 14 or each body terminal cell 30 may supply a second body bias voltage VB2 to each body terminal of the plurality of logic gates 20 of the logic gate region 16 or 16A as a body bias voltage VB when a level of an enable signal EN is high level (S43).

According to another embodiment, the body bias voltage control circuit 14 or each body terminal cell 30 may select the first body bias voltage VB1 when a level of the enable signal EN is high level, and select the second body bias voltage VB2 when a level of the enable signal EN is low level.

FIG. 17 is a block diagram of a semiconductor system including the semiconductor device according to an embodiment of the inventive concept. Referring to FIG. 17, a semiconductor device 10, such as the one illustrated in FIG. 1, is included in a semiconductor system 100. The semiconductor system 100 may be a cellular phone, a smart phone, a tablet PC, a personal digital assistant (PDA), or a wireless communication device.

The semiconductor system 100 comprises the semiconductor device 10 and a controller 150 which may control an operation of the semiconductor device 10. The controller 150 may control a data access operation, e.g., a program operation, an erase operation or a read operation, of the semiconductor device 10 according to a control of a processor 110.

A page data programmed in the semiconductor device 10 may be displayed through a display 120 according to a control of the processor 110 and/or the controller 150.

A radio transceiver 130 may transmit or receive a radio signal through an antenna ANT. For example, the radio transceiver 130 may convert a radio signal received through the antenna ANT into a signal which may be processed by the processor 110. Accordingly, the processor 110 may process a signal output from the radio transceiver 130 and transmit a processed signal to the controller 150 or the display 120. The controller 150 may program a signal processed by the processor 110 in the semiconductor device 10. In addition, the radio transceiver 130 may convert a signal output from the processor 110 into a radio signal and output a converted radio signal to an external device through the antenna ANT.

An input device 140 is a device which may input a control signal for controlling an operation of the processor or data to be processed by the processor 110, and may be embodied in a pointing device such as a touch pad and a computer mouse, a keypad or keyboard.

The processor 110 may control an operation of the display 120 so that data output from the controller 150, data output from the radio transceiver 130 or data output from the input device 140 may be displayed through the display 120.

According to the illustrated embodiment, the controller 150 which may control an operation of the semiconductor device 10 may be embodied in a part of the processor 110 or a separate chip from the processor 110.

FIG. 18 is a block diagram depicting another semiconductor system incorporating a semiconductor device according to an embodiment of the inventive concept. Referring to FIG. 18, a semiconductor system 200 may be a personal computer (PC), a tablet PC, a net-book, an e-reader, a personal digital assistant (PDA), a portable multimedia player (PMP), a MP3 player or a MP4 player. The semiconductor system 200 comprises a semiconductor device 10 and a controller 240 that controls a data processing operation of the semiconductor device 10.

The processor 210 may display data stored in the semiconductor device 10 through a display 230 according to data input through an input device 220. For example, the input device 220 may be embodied in a pointing device such as a touch pad or a computer mouse, a keypad or a keyboard. The processor 210 may control a whole operation of the semiconductor system 200 and control an operation of the controller 240. According to the illustrated embodiment, the controller 240 controlling the operation of the semiconductor device 10 may be embodied, at least in part, within the processor 210.

FIG. 19 is a block diagram depicting still another semiconductor system incorporating a semiconductor device according to an embodiment of the inventive concept. Referring to FIG. 19, a semiconductor system 300 may be a memory card or a smart card. The semiconductor system 300 includes the semiconductor device 10, a controller 310 and a card interface 320.

The controller 310 may control data exchange between the semiconductor device 10 and the card interface 320. The card interface 320 may be a secure digital (SD) card interface or a multi-media card (MMC) interface in certain embodiments.

The card interface 320 may interface data exchange between a host 330 and the controller 310 according to a protocol of a host 330. According to an embodiment, the card interface 320 may support a universal serial bus (USB) protocol and an inter-chip (IC)-USB protocol. Here, the card interface may mean hardware which may support a protocol that a host 330 uses, software embedded in the hardware or a signal transmission mode.

When the semiconductor system 300 is connected to a host interface 350 of the host 330 such as a PC, a tablet PC, a digital camera, a digital audio player, a cellular phone, console video game hardware or a digital set-top box, the host interface 350 may perform a data communication with the semiconductor device 10 through the card interface 320 and the controller 310 according to a control of a microprocessor 340.

FIG. 20 is a block diagram depicting still another semiconductor system incorporating a semiconductor device according to an embodiment of the inventive concept. Referring to FIG. 20, a semiconductor system 400 may be an image processing device, e.g., a digital camera, a digital camera-equipped cellular phone, a digital camera-equipped smart phone or a digital camera-equipped tablet PC.

The semiconductor system 400 comprises the semiconductor device 10 and a controller 440 that controls a data processing operation, (e.g., a program operation, an erase operation or a read operation) of the semiconductor device 10.

An image sensor 420 of the semiconductor system 400 converts an optical image into digital signals, and converted digital signals are transmitted to a processor 410 or a controller 440. According to a control of the processor 410, the converted digital signals may be displayed through a display 430 or stored in the semiconductor device 10 through the controller 440.

In addition, data stored in the semiconductor device 10 are displayed through the display 430 according to a control of the processor 410 or the controller 440.

According to an embodiment, the controller 440 which may control an operation of the semiconductor device 10 may be embodied in a part of the processor 410 or a separate chip from the processor 410.

FIG. 21 is a block diagram depicting still another semiconductor system incorporating a semiconductor device according to an embodiment of the inventive concept. Referring to FIG. 21, a semiconductor system 500 comprises the semiconductor device 10 and a central processing unit (CPU) 510 that controls an operation of the semiconductor device 10. The semiconductor system 500 includes a memory device 550 which may be used as an operation memory of the CPU 510. The memory device 550 may be embodied in a non-volatile memory such as a read only memory (ROM) or a volatile memory such as a static random access memory (SRAM).

A host connected to the semiconductor system 500 may perform data communication with the semiconductor device 10 through an interface 520 and a host interface 540.

An error correction code (ECC) block 530 may detect an error bit included in data output from the semiconductor device 10 through the interface 520, correct the error bit and transmit error-corrected data to a host through the host interface 540 according to a control of the CPU 510.

The CPU 510 may control data communication among the interface 520, the ECC block 530, the host interface 540 and the memory device 550 through a bus 501.

The semiconductor system 500 may be a flash memory drive, a USB memory drive, an IC-USB drive or a memory stick.

FIG. 22 is a block diagram depicting still another semiconductor system incorporating a semiconductor device according to an embodiment of the inventive concept. Referring to FIG. 22, a semiconductor system 600 may be a data processing device such as a sold state drive (SSD). The semiconductor system 600 may include a plurality of semiconductor devices 10, a controller 610 which may control each data processing operation of the plurality of semiconductor devices 10, a volatile memory device 630 such as a DRAM, and a buffer manager 620 controlling storage of data, which is transmitted or received between the controller 610 and a host 640, in the volatile memory device 630.

Certain methods and semiconductor devices according to embodiments of the inventive concept use an enable signal to gate application of a clock signal to a synchronization element included within a logic gate region. This controlled application of a clock signal may be used to control a body bias voltage supplied to each of a plurality of logic gates in the logic gate region. Accordingly, not only is the operating speed of the constituent elements in the logic gate region improved, but also active leakage is reduced.

Although certain embodiments of the general inventive concept have been shown and described, it will be appreciated by those skilled in the art that changes may be made in these embodiments without departing from the principles of the general inventive concept, the scope of which is defined in the appended claims and their equivalents.

What is claimed is:

1. A method of controlling the provision of a body bias voltage to a logic gate region of a semiconductor device, the method comprising:
gating application of a clock signal applied to a synchronization element in the logic gate region in accordance with an enable signal; and
providing the body bias voltage to each body terminal of a plurality of logic gates arranged in the logic gate region in accordance with the enable signal.

2. The method of claim 1, wherein the enable signal is a phase-controlled enable signal.

3. The method of claim 1, wherein the body bias voltage is applied in a reverse direction to each body terminal in accordance with a first state of the enable signal, and in one of a forward direction and a basic body bias voltage to each body terminal in accordance with a second state of the enable signal.

4. The method of claim 1, wherein the body bias voltage is one of a plurality of body bias voltages selected in accordance with the enable signal.

5. The method of claim 1, wherein providing the body bias voltage to each body terminal includes reading control information stored in a programmable memory.

6. A semiconductor device comprising:
a logic gate region including a synchronization element responsive to a clock signal and a plurality of logic gates each respectively including a body terminal, wherein each body terminal receives a body bias voltage in response to an enable signal; and
a gating circuit that receives the clock signal and provides the clock signal to the synchronization element in accordance with the enable signal.

7. The semiconductor device of claim 6, further comprising:
a voltage control circuit that provides the body bias voltage to each body terminal of the plurality of logic gates in accordance with the enable signal.

8. The semiconductor device of claim 6, further comprising:
a body bias voltage generator that generates a plurality of body bias voltages, and
a voltage control circuit that selects one of the plurality of body bias voltages as the body bias voltage in response to a state of the enable signal.

9. The semiconductor device of claim 6, wherein the body bias voltage is applied in a reverse direction to each body terminal in accordance with a first state of the enable signal, and in one of a forward direction and a basic body bias voltage to each body terminal in accordance with a second state of the enable signal.

10. The semiconductor device of claim 6, further comprising:
a phase control circuit that controls a phase of the enable signal.

11. The semiconductor device of claim 6, wherein each of the plurality of logic gates comprises a body terminal cell that receives a plurality of body bias voltages and selects between the plurality of body bias voltages in accordance with a state of the enable signal to define the body bias voltage.

12. The semiconductor device of claim 11, further comprising:
a body bias voltage generator that generates the plurality of body bias voltages.

13. A semiconductor system comprising:
one or more CPUs;
a plurality of functional blocks; and
a bus providing connections among said one or more CPUs and said plurality of functional blocks,
wherein at least one of said one or more CPUs, said plurality of functional blocks and said bus comprises:
a logic gate region including a synchronization element responsive to a clock signal and a plurality of logic gates each respectively including a body terminal, wherein each body terminal receives a body bias voltage in response to an enable signal; and
a gating circuit that receives the clock signal and provides the clock signal to the synchronization element in accordance with the enable signal.

14. The semiconductor system of claim 13, wherein at least one of said one or more CPUs, said plurality of functional blocks and said bus further comprises:
a voltage control circuit that provides the body bias voltage to each body terminal of the plurality of logic gates in accordance with the enable signal.

15. The semiconductor system of claim 13, wherein at least one of said one or more CPUs, said plurality of functional blocks and said bus further comprises:
a body bias voltage generator that generates a plurality of body bias voltages and
a voltage control circuit that selects one of the plurality of body bias voltages as the body bias voltage in response to a state of the enable signal.

16. The semiconductor system of claim 13, wherein at least one of said one or more CPUs, said plurality of functional blocks and said bus further comprises a phase control circuit that controls a phase of the enable signal.

17. The semiconductor system of 13, wherein each of the plurality of logic gates comprises a body terminal cell that receives a plurality of body bias voltages and selects between the plurality of body bias voltages in accordance with a state of the enable signal to define the body bias voltage.

18. The semiconductor system of claim 17, wherein the semiconductor device further comprises a body bias voltage generator that generates the plurality of body bias voltages.
